(19) United States
(12) Patent Application Publication
(10) Pub. No.: US 2008/0070616 A1
(43) Pub. Date: Mar. 20, 2008

(54) Mobile Communication Terminal with Improved User Interface

(75) Inventor: Sung-Kyoon Yun, Gyeonggi-do (KR)

Correspondence Address: CANTOR COLBURN, LLP, 20 Church Street, 22nd Floor, Hartford, CT, 06103, US

(73) Assignee: NEOMTEL CO., LTD., Seoul (KR)

(21) Appl. No.: 11/577,204

(22) PCT Filed: Nov. 14, 2005
(86) PCT No.: PCT/KR05/04284

§ 371 Date: Apr. 13, 2007

(30) Foreign Application Priority Data
Dec. 14, 2004 (KR) 10-2004-0105671

(51) Int. Cl. H04M 1/00

(52) U.S. Cl. 455/550.1

(57) ABSTRACT

A user interface technique of a mobile communication terminal is disclosed. The mobile communication terminal includes a memory unit storing menu content that includes object files constituting multimedia of nodes in a tree-structured menu and playback control commands combining the object files to generate a playback frame and defining a next operation responding to an event inputted by a user; and a menu playback unit playing the menu content stored in the memory unit in response to the event inputted by the user by outputting nodes constituting the menu by repeatedly performing a process of combining the object files and generating and outputting the playback frame according to the playback control commands in response to the event, and calling a function corresponding to the event and providing a corresponding menu function when a lowermost menu node is played.

### TECHNICAL FIELD

The present invention relates to a user interface of a mobile communication terminal and, more particularly, to a method of providing a menu screen for changing setup configuration or for providing supplementary functions in the mobile communication terminal.

### BACKGROUND ART

Korean Patent Application Publication No. 2003-17594, invented by Kim Hyung Cheol and published on Mar. 3, 2003, discloses a method of updating a menu icon of a mobile communication terminal by the use of a file transmitted in SMS. According to the publication, icons received in SMS are stored in an icon area of a memory and are edited and stored in the mobile communication terminal, thereby changing a menu configuration.

However, the publication does not disclose a method of changing a function of a menu by changing the order of icons which correspond to graphic data. In addition, the method is not efficient since the menu configuration is edited in the mobile communication terminal. Further, the publication does not disclose a method of providing a multimedia menu.

### DISCLOSURE OF INVENTION

### Technical Solution

The present invention provides a multimedia content menu in a mobile communication terminal.

The present invention further provides a method of setting a menu screen according to individual tastes.

The present invention further provides a method of conveniently updating content constituting a menu of a mobile communication terminal.

### ADVANTAGEOUS EFFECTS

Since the menu of the mobile communication terminal is provided in content executed by a playback engine instead of being provided in combination with hardware, it is possible to change and update the menu any time.

In addition, according to the present invention, it is possible to set screens for menus according to individual tastes.

In addition, since the menu content is played in frame units, it is possible to provide the menu content in multimedia having graphics, moving images, and audio.

Further, according to the present invention, users can update content constituting the menu of the mobile communication terminal through the use of files received over a network, images taken by a camera, or sound source files stored in a memory.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile communication terminal according to an embodiment of the present invention;

FIG. 2 is a block diagram of a configuration of menu content according to an embodiment of the present invention;

FIG. 3 is a flow chart of a method of providing a menu in a multimedia terminal according to an embodiment of the present invention; and

FIGS. 4 and 5 are flow charts of methods of updating content according to embodiments of the present invention.

### BEST MODE FOR CARRYING OUT THE INVENTION

According to an aspect of the present invention, there is provided a mobile communication terminal including: a memory unit storing menu content that includes object files constituting multimedia of nodes in a tree-structured menu and playback control commands combining the object files to generate a playback frame and defining a next operation responding to an event inputted by a user; and a menu playback unit playing the menu content stored in the memory unit in response to the event inputted by the user, outputting nodes constituting the menu by repeatedly performing a process of combining the object files and generating and outputting the playback frame according to the playback control commands in response to the event, and calling a function corresponding to the event and providing a corresponding menu function when a lowermost menu node is played.

The mobile communication terminal may further include a menu update unit that monitors whether or not an update event occurs and updates at least one of the object files or the playback control command files constituting the menu content when the update event occurs.

Accordingly, it is possible to update files constituting multimedia in a menu screen, and a tree structure and operation between the files. In addition, it is possible to partly or entirely update the appearance and function of the menu screen. That is, event though Korean Patent Application Publication No. 2003-17594 does not disclose a method of processing functions related to icons upon changing the order of the icons, the above-mentioned method can be implemented in the present invention by updating a playback control command which is responsible for calling functions concerning a connection between menu nodes and a lowermost menu.

The menu content may be updated by files received through a wireless communication unit.

The menu content may be updated by image information including a still image or a moving image taken by a camera unit.

### MODE FOR THE INVENTION

Exemplary embodiments in accordance with the present invention will now be described in detail with reference to the accompanying drawings.

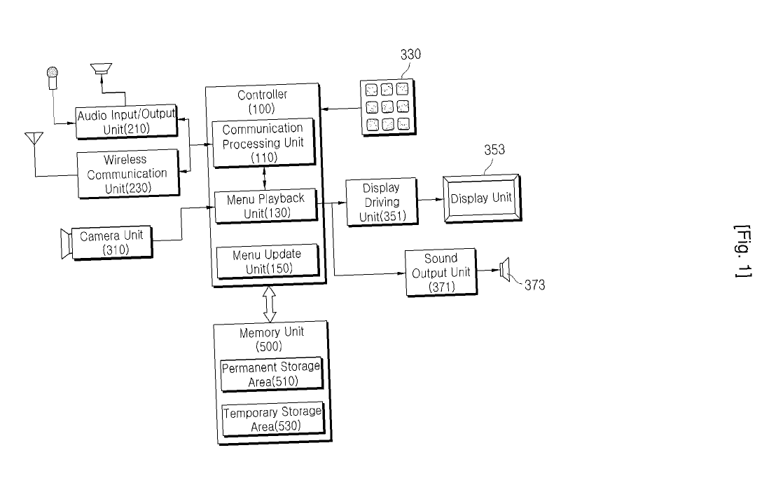

FIG. 1 is a block diagram of a mobile communication terminal according to an embodiment of the present invention.

The mobile communication terminal includes a wireless communication unit 230, which transmits and receives data over a mobile communication network, a communication processing unit 110, which processes audio and data signals transmitted and received through the wireless communication unit 230, and an audio input/output unit 210, which converts the audio signal processed by the communication processing unit 110 into an audible sound or receives and outputs an external audio signal to the communication processing unit 110.

In addition, the mobile communication terminal includes a memory unit 500 and a menu playback unit 130. The memory unit 500 stores menu content that includes object files, which constitute multimedia of each of nodes in a tree-structured menu, and playback control commands, which combine the object files to generate playback frames or define an operation responding to an event inputted by a user. The menu playback unit 130 plays the menu content stored in the memory unit 500 in response to an event inputted by the user. At this time, the menu playback unit 130 outputs nodes constituting the menu by repeatedly performing steps of combining the object files to generate the playback frames and outputting the generated playback frames according to the playback control command, and calls a function corresponding to the event inputted by the user and provides a corresponding menu to play a lowermost menu node.

The wireless communication unit 230 includes an antenna and an RF circuit for communication with base stations. The audio input/output unit 210 transmits voice to a user and converts voice received from the user through a microphone. That is, the audio input/output unit 210 converts digital audio data to an analog audio signal or vice versa, and includes an audio amplifier, a filter, or the like.

The communication processing unit 110 demodulates and decodes a signal received from the wireless communication unit 230 into digital audio/non-audio data, or vice versa. A baseband circuit of the wireless communication unit 230 and a large part of circuits of the controller 100 are integrated into a commercially available IC chip. The IC chip includes hardware dedicated for communication processing, a digital signal processor, and a general-purpose microprocessor.

Examples of the keypad 330 include a key input device of the mobile communication terminal, and a touch-panel input device of a personal digital assistant (PDA). An example of the display unit 353 is a liquid crystal display (LCD) device. Image data outputted from the menu playback unit 130 is processed by the display driving unit 351 and is converted to an analog signal to drive the display unit 353. The term ‘display unit’ may be used as a display device including supplementary circuits such as a display driving unit and the like.

The sound output unit 371 converts an audio signal outputted from the menu playback unit 130 into an audible signal and outputs it through a speaker 373. The sound output unit 371 is a well-known circuit including a digital/analog converter, an amplifier, and the like. The sound output unit 371 and the speaker may output sound in mono, stereo, or more channels.

The memory unit 500 may include a single or a plurality of memory modules. The permanent storage area 510 may be a non-volatile memory such as ROM, flash memory, or hard disk. The temporary storage area 530 may be a volatile memory such as RAM. The permanent storage area 510 and the temporary storage area 530 may be formed in a single flash memory.

A content file stored in the memory unit 500 includes a header, which includes content summary information, object files, which constitute multimedia content, and playback control commands, which operate the object files and describe the content.

In one embodiment, the menu playback unit 130 is incorporated in a mobile communication as an engine for playing the content. The menu playback unit 130 reads menu content stored in the permanent storage area 510 of the memory 500 into the temporary storage area 530 and plays the menu content. In addition, the menu playback unit 130 checks whether or not elements of the content exist in the permanent storage area 510 of the memory unit 500, loads the elements into the temporary storage area 530 of the memory 500, and plays the element. In case there are updated elements, the menu playback unit 130 loads the updated elements into the temporary storage area 530 and plays the updated elements.

The playback engine of the playback unit 130 reads a content file from the permanent storage area 510 of the memory unit 500 into the temporary storage area 530. At this time, the playback engine loads the object files from the information included in the header into a resource area, reads the playback control command into an action area, sequentially reads and plays the object files loaded in the resource area according to the playback control command stored in the action area. In case the content is updated, the update engine loads the updated file into the temporary storage area and plays the updated file. The term ‘action’ in the present invention implies a sequence of playback control commands constituting a single operation. Accordingly, when one of the object files constituting original content is changed to another file, which has the same file name as but different data than the object file, and the changed content is stored in the permanent storage area 510, the changed content is played back when the content is executed.

For example, each of the playback control commands controls a display order of a series of frames or a delay time of the series of frames, and defines content to be displayed in each of the frames. The respective frames may be displayed by overlapping a plurality of layers of images on a background image with transparent margins. In addition to the images, sounds can be controlled in synchronization with playback of the respective frames. Accordingly, it is possible to produce various multimedia contents by combining the playback control commands and the object files.

The playback control command includes an action command for playback control, and a script file for describing the size, operation, and characteristic of an object. Each of the object files may be one of image file, sound file, and moving image file, or another content file.

The action command defines graphic layers constituting a frame by drawing a vector image or changing the attribute of a raster image, and includes a command for controlling the playback of an audio file to be played together with the frame. The script is a command which changes the attribute of objects included in the content or calls a predefined function to change the content. That is, the script is a command which allows users to easily change the content. The script may be operated in response to an event such as a keyboard or a timer.

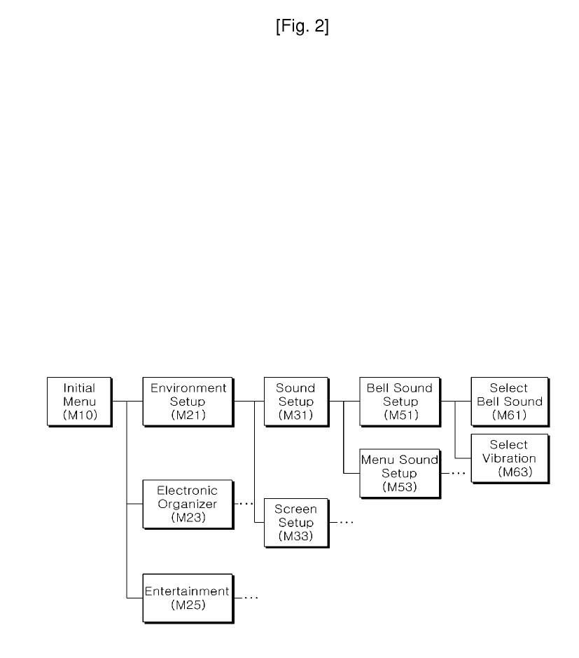

FIG. 2 is a configuration of menu content according to an embodiment of the present invention. Menu content M10 is initial content executed upon selecting a menu key, and displays menu icons such as an environment setup icon, an electronic note icon, an entertainment icon, and the like. The present invention may provide various types of multimedia menu, such as a list or a character, in addition to the icon. The menu content has a tree structure. The respective nodes M10, M21, M23, . . . , M63 constituting the tree structure may be content files according to the present invention. For example, when the environment setup icon is selected, environment setup menu content M21 is played. The environment setup content is displayed, for example, as a character moving in a background image that is taken by a camera, and menus such as sound setup and screen setup are displayed in a space designated by the character. When a user moves a cursor to select the sound setup, sound setup menu content M31 displaying icons, such as bell sound and vibration, is played. When the bell sound is selected, bell sound selection menu content M51 is played. When the user selects a sound item from a sound source list in the content, one of playback control commands for controlling bell sound selection content M61 calls a function for setting a bell sound of a mobile communication terminal and sets the sound item as the bell sound. The function can directly access hardware of the mobile communication terminal and is generally programmed and provided for each of the mobile communication terminals.

The multimedia content format according to the present invention supports an action command which refers to external content and executes an external content file. For example, a user responds to an event for selecting a lower menu and loads and executes content corresponding to the menu, such that the entire menu is played. In this case, each of the nodes constituting the menu tree shown in FIG. 2 forms a single content file. The content file includes a specific event for selecting a lower menu, for example, a playback control command for playing content corresponding to the lower menu in response to operation of selecting an icon indicated by a cursor. The lowermost menu content calls a function for applying a value set by a user to hardware, or calls another application program such as a multimedia player.

In another embodiment, the entire menus constituting a tree structure may form a content file. In this case, an event that a user selects a menu is checked by an action command constituting the content, and a frame corresponding to the next menu is generated and played in response to the event.

The menu content includes layers of picture images, graphic image frames, or a combination thereof. The moving images are consecutively played by controlling the number of frames per second of a moving image or the display time of each frame. In addition, a layer of text may be added to the moving image frame, and audio may be added by controlling playback of an audio file in synchronization with the frame. Such a control can be performed by the action command or script.

The script command describes the size, operation, and characteristic of objects constituting a content file. The scrip command serves to allow users to easily change or control objects on the content. The script command can be conveniently written by the users through an authoring tool for authoring the content according to the present invention. The content authoring tool loads various object files for each frame, and provides a graphic user interface for defining the attribute and characteristic of the object files.

The operation of the menu update unit 150 is defined by an update script included in the content, and updates the content or at least one of object files constituting the content file. In addition, the menu update unit 150 notifies the menu playback unit 130 that the content has been updated, so that the menu playback unit 130 can play the updated frame. For example, a user can enjoy a menu represented in a new multimedia content by replacing a specific object file constituting a frame in a content file constituting a node of the menu by a new file. The user can change partly or completely change the menu tree structure by updating the playback control command file, such that the user can configure a desired menu display.

For example, the user selects a model number of a mobile communication terminal in a Web server, combines various menus in the mobile communication terminal using various templates provided from the Web server to configure a menu tree, and configures a unique multimedia content for the respective nodes constituting the tree, such that the user interface, i.e., the menu, of the mobile communication terminal may be commercialized as a content product.

In one embodiment, the menu update unit 150 monitors whether or not an update event occurs. When the update event occurs, the menu update unit 150 updates at least one of object file and playback control file constituting the menu content.

In one embodiment, the update control unit 150 is a routine executed as an independent thread which is operated when the menu playback unit 130 is activated. The menu update unit 150 updates the object and notifies the playback unit 130 that the content has been updated. The menu playback unit 130 reads the updated object file or the entire content file from the permanent storage area 510 into the temporary storage area 530, and plays the updated content. Accordingly, it is possible to change and play the content while the content is played. In the present embodiment, the menu update unit 150 manages a script which defines a definition of an event and an action corresponding to the defined event, and monitors whether or not the defined event occurs. When the event occurs, the menu update unit 150 executes an action corresponding to the event.

In another embodiment, the menu update unit 150 may be a conceptual expression of playback control commands which are distributed in the menu playback unit 130. That is, among the playback control commands, a command to generate a frame and/or a command to output the generated frame includes a definition of an event which causes execution of a script that defines a specified action. For example, when a ‘SEND’ button of a mobile phone is pushed while the playback engine is playing a specified content, a command to generate a frame executes a predetermined script in response to this event. The script may be configured to update part of an object of the content which is currently played through a network.

In another embodiment, the menu update unit 150 can change the menu content to a file received through the wireless communication unit 230. For example, the playback control command may include information concerning addresses of network resources that provide content to be updated. The menu update unit 150 may access the network resource through the wireless communication unit 230 under the control of the playback control command, receive and update the content or object files that constitute the content.

An example of the script is described as follows:

ext_importMovie(http://211.233.24.178/vis20Dm/files/photones1.vis, “newm”, “loading”, “nerror”);

ext_replaceMovieClip(“oldm”, “newm”)

ext_saveResource(“newm”)

The function ext_importMovie( ) is a function of receiving a file from a network and making it a movie clip symbol. The function ext_replaceMovieClip( ) is a function of replacing an existing movie clip with the movie clip symbol received from the network. The function ext_saveResource( ) is a function of storing the movie clip symbol in the permanent storage area 510, and allowing the updated movie clip information to be played. When the function ext_importMovie( ) is executed, a mobile communication terminal requests and receives a corresponding file from URL, which is defined in a parameter, using the HTTP protocol. If the replaced movie clip information is not stored in the permanent storage area 510, the content, which is not updated and is stored in the permanent storage area 510, will be played back.

Even though the above-mentioned embodiment describes updating of the object file, a new operation may be included upon playing the menu by downloading and updating a script file. For example, when the menu is selected, a character different from an existing character may be played, or the position or motion of the character may be changed so that a user can feel differently.

In another embodiment, the menu update unit 150 can change the content or its elements to an image or a moving image inputted from the camera unit 310 under the control of the playback control commands.

An image taken by the camera unit 310 can replace a specific object in a frame to be currently played. For example, suppose that a specific part of menu content consists of ten frames each having a background layer, a first layer of a star photo, a second layer of the star's companion, and a third layer of clothes and accessories of the companion. In case the background layer has an unchanged image and the first to third layers are changed in reference position upon displaying, a file corresponding to the second layer can be replaced by a user's image file so that images of the user and the star can be displayed in the ten frames. In the present embodiment, the updated images need to be stored in the permanent storage area 510 so that the updated images can be played.

In one embodiment, an update script defining the menu update unit 150 is related to a frame generated in content. A playback control command for generating each frame checks whether or not there is a script related to the frame before and/or after generating the frame. In another embodiment, the menu update unit 150 monitors whether or not a specific event occurs. When the event occurs, the menu update unit 150 changes a script file in the content file to a script file downloaded from the wireless communication unit 230. That is, when the specific event occurs, the menu update unit 150 accesses a content server having a network address designated through the wireless communication unit 230 to download a new script file and updates a previous script file.

The operation of the menu update unit 150 is controlled by another update script file loaded into the script area. An event for updating may be one of a key operation event or a timer event. For example, when a specific key is pressed, the script file may be updated. For another example, the script may be updated periodically, for example, every day or month.

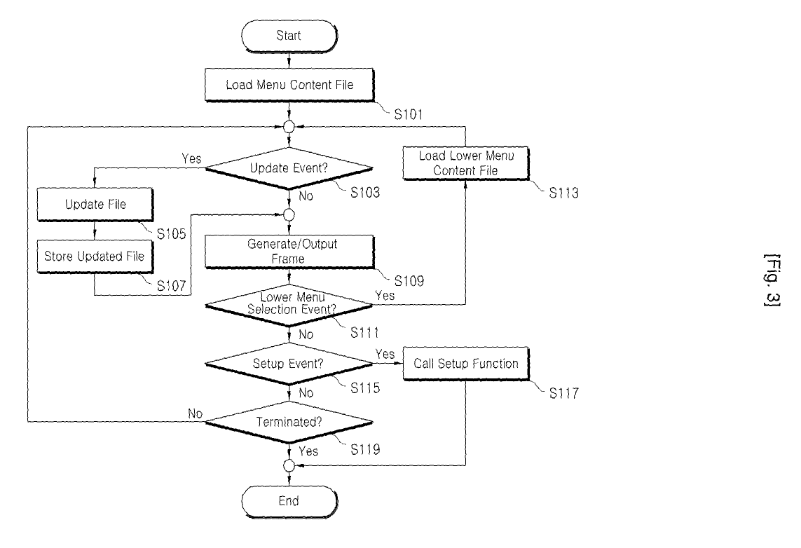

FIG. 3 is a flow chart of a method of providing a menu in a multimedia terminal according to an embodiment of the present invention. The present invention can be applied to a typical multimedia terminal equipped with a menu playback engine according to the present invention, such as an audio player, a personal media player (PMP), and a digital camera, in addition to a mobile communication terminal.

The method of providing a menu according to the present invention includes: acquiring information concerning object files, which constitute multimedia of nodes in a tree-structured menu, and playback control commands, which generate combined object files or defining a next operation in respond to an event, from header information of menu content, and loading the object files into a resource area and loading the playback control commands into an action area by the use of the acquired information (S101); outputting one of the nodes constituting the menu by repeatedly performing a process of generating and outputting a playback frame by combining the object files according to the playback control commands in response to the event inputted by the user (S103 to S111); and, when playing a lowermost menu node, calling a function corresponding to the event and providing a corresponding menu (S115 and S117).

In one embodiment, a content file includes a header including content summary information, object files constituting multimedia content, and playback control commands. The respective object files may be at least one of image, sound, and moving image files. The content file may be recorded on a storage medium such as a CDROM or a hard disk of a host computer, or be transmitted through a network. The content file may be compressed into a single file to reduce the file size when it is transmitted on the network. The present invention includes a recording medium storing the content according to the present invention.

The menu playback unit 130 reads the content file stored in the permanent storage area 510 of the memory unit into the temporary storage file (operation S101). When the file is compressed and stored, the operation of decompressing the file may be added before operation of reading the file. The playback unit 130 loads object files into the resource area from information included in the header, and reads the playback control command in the action area.

In one embodiment, it is monitored whether or not an update event occurs before and/or after a frame is generated. In case the update event occurs, at least one of object file and playback control file constituting the menu content can be updated. That is, the menu update unit 150 checks a queue in which events are stored, and checks whether or not there is an action defined in connection with the current event (operation S103). For example, the menu update unit 150 checks a keypad queue to check whether or not there is an action regarding a key or a set of keys.

If there is a corresponding action, the corresponding content or at least one of the elements of the content file stored in the resource area is changed to a new element under the control of the playback control command included in the action (operation S105). In this case, the element preferably has the same file name as but different data than the existing element since it is not necessary to change the playback control command. In this operation, the content stored in the temporary storage area 530 of the memory unit 500 is updated. The update operation of the menu update unit 150 that is performed by checking the event queue and processing the corresponding action is preferably performed before and/or after each frame is generated since the frames are frequently output at regular speeds.

After the file is updated in the temporary storage area, operation S109 is further included in which an element of the updated content file replaces corresponding content or an element of the content stored in the permanent storage area 510 of the memory unit 500. Accordingly, when the playback engine is terminated and restarted, the updated content is loaded and played back. The playback unit 130 checks the playback control commands. If the playback operation of the content file is not completely terminated, it returns to the operation 103 to generate next frame data. If terminated, the process is terminated (operation S107).

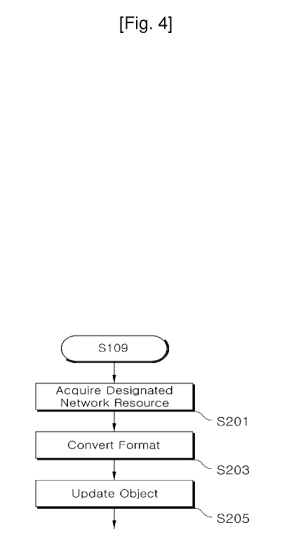

FIG. 4 is an embodiment of the operation S107 according to the present invention. In the present embodiment, the menu update unit 150 updates menu content to a file received through the wireless communication unit 230. For example, when a corresponding event occurs, the menu update unit 150 changes at least one of elements of the corresponding content file to a file received by accessing address information of the network resource included in the playback control command. That is, when there is a corresponding action, the corresponding content or at least one of elements of the corresponding content is received by accessing the corresponding resource from the address information of the network resource included in the playback control command (operation S201).

In addition, the received file may be subjected to decompression, scaling, or format conversion operation (operation S203). Subsequently, the converted object file or content file replaces the corresponding existing object file or content file which is loaded into the temporary storage area 530 (operation S205).

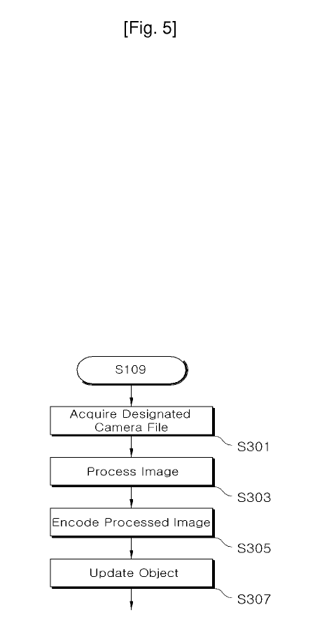

FIG. 5 is another embodiment of operation S107 according to the present invention. In the present embodiment, the menu update unit 150 updates one of the object files to an image inputted from a camera unit 310. In the present embodiment, when the corresponding event occurs, the menu update unit 150 changes at least one of elements of the corresponding content file to an image or a moving image inputted from the camera unit 310 incorporated in a mobile communication terminal. That is, when there is a corresponding action, an image or a moving image inputted from the camera unit 310 is acquired (operation S301).

The image acquired from the camera unit 310 may be converted and encoded to be suitable for a desired object file. That is, only a part of the image or moving image, which is required for the content, is extracted and processed to have a suitable image format (operation S303). For example, if an object file for a facial part is required, the facial part is extracted from a photo and the remaining part is processed to be transparent. At this time, image processes, such as zooming, brightness or contrast control, may be added. The processes may be performed manually by a user, automatically by image recognition, or by a combination thereof.

The processed image is encoded to a format which is compatible with the content according to the present invention (operation S305). The mobile communication terminal is preferably equipped with an encoder. The encoded object file or content file replaces the corresponding object file or content file loaded in an existing temporary storage area 530 (operation S307).

In case there is no update action defined for a combination of events available in a current event queue, the process proceeds to the next operation without the action, and the menu playback unit 130 controls the system instead of the menu update unit 150.

The menu playback unit 130 sequentially reads the object files loaded into the resource area according to the playback control command stored in the action area and generates and outputs frame data to be played (operation S109). A plurality of object files, such as plurality of image files constituting a plurality of layers of each frame and a plurality of sound files to be played in synchronization with the frame, may be required to play a single frame. First, a first frame of an uppermost menu M10 among the menu of FIG. 2 is generated and output. Next, it is checked whether or not an event for selecting a lower menu occurs when the frame is played (operation S111). When the lower menu is selected, menu content corresponding to the lower menu is loaded from the permanent memory (operation S113). However, in case the menu is made of a single content, this process corresponds to branching to another block of the content for generating another frame. Subsequently, the process returns to operation S103.

When the event for selecting the lower menu does not occur, a setup event is checked (operation S115). The setup event sets a bell sound, changes an initial screen, reads/edits a phone book, or the like in the lowermost menu. The setup event is provided by calling a function or another application program for operating hardware (operation S117). The term ‘setup function’ in the present embodiment implies an external function or program for implementing the menu. The external function or program may be provided from a terminal manufacturer or a company manufacturing menu content with the aid of the terminal manufacturer. The menu function is terminated after calling the setup function. The setup event may occur by inputting a hot key in an intermediate menu rather than in the lowermost menu.

In case the setup event does not occur, it is checked whether or not a termination key is selected (operation S119). When the termination key is not selected, the process returns to operation S103 to play the next frame. When the termination key is selected, the playback of the menu content is terminated.

Even though the update event, menu selection event, and setup event, and termination key input are sequentially checked in the above-mentioned embodiment, the present invention is not limited to the above-mentioned order. Further, the events may be checked at regular intervals in response to a timer event rather than before and after each frame is generated.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be applied to a method of providing a menu screen for changing setup configuration or for providing supplementary functions in the mobile communication terminal.

1.-11. (canceled)

12. A mobile communication terminal comprising:
a memory unit storing menu content that includes object files constituting multimedia of nodes in a tree-structured menu and playback control commands combining the object files to generate a playback frame and defining a next operation responding to an event inputted by a user;
a menu playback unit playing the menu content stored in the memory unit in response to the event inputted by the user, outputting nodes constituting the menu by repeatedly performing a process of combining the object files and generating and outputting the playback frame according to the playback control commands in response to the event, and calling a function corresponding to the event and providing a corresponding menu function when a lowermost menu node is played; and
a menu update unit that monitors whether or not an update event occurs and updates at least one of the object files or the playback control command files constituting the menu content when the update event occurs.

13. The mobile communication terminal of claim 12, wherein the menu update unit is operated upon activating the menu playback unit, and, if the content is updated, notifies the menu playback unit that the content has been updated so that the menu playback unit can load and play the updated content.

14. The mobile communication terminal of claim 12, further comprising:
a wireless communication unit transmitting and receiving data over a mobile communication network;
a communication processing unit processing audio and data signals transmitted and received through the wireless communication unit; and
an audio input/output unit converting an audio signal processed by the communication processing unit into audible sound or converting and transmitting an external audio signal to the communication processing unit,
wherein the menu update unit updates the menu content to a file received through the wireless communication unit.

15. The mobile communication terminal of claim 12, further comprising a camera unit talking an image, wherein the menu update unit updates one of the object files to the image inputted to the camera unit.

16. A method of providing a menu in a mobile communication terminal, the method comprising the operations of:
a) acquiring information concerning object files, which constitute multimedia of nodes in a tree-structured menu, and playback control commands, which combines the object files to generate a playback frame and defines a next operation responding to an event inputted by a user, from header information of menu content;
b) loading the object files and the playback control commands into a resource area and an action area, respectively, by the use of the acquired information;
c) outputting nodes constituting the menu by repeatedly performing a process of combining the object files and generating and outputting the playback frame according to the playback control commands in response to the event inputted by the user; and
d) calling a function corresponding to the event and providing a corresponding menu function when a lowermost menu node is played,
wherein the operation c) further comprises c1) monitoring whether or not an update event occurs and updating at least one of the object files or the playback control command files constituting the menu content when the update event occurs.

17. The method of claim 16, wherein, in the operation c), the menu content is updated to a file received through a wireless communication unit.

18. The method of claim 16, wherein, in the operation c), one of the object files is updated to an image inputted from a camera unit.

19. The method of claim 18, wherein the operation c) further includes converting and encoding the image inputted from the camera unit to be suited for a desired object file.

20. A computer-readable recording medium storing the method of claim 16.
